(19) United States
(12) Patent Application Publication
(10) Pub. No.: US 2002/0059255 A1
(43) Pub. Date: May 16, 2002

(54) Apparatus and method for operating an information deposit and retrieval system with resource property system

(76) Inventor: William Chyi Wu, Fremont, CA (US)

Correspondence Address: OPPENHEIMER WOLFF & DONNELLY, P. O. BOX 10356, PALO ALTO, CA, 94303, US

(21) Appl. No.: 09/976,449

(22) Filed: Oct. 12, 2001

Related U.S. Application Data
(60) Provisional application No. 60/240,376, filed on Oct. 13, 2000.
(60) Provisional application No. 60/240,375, filed on Oct. 13, 2000.

(51) Int. Cl. G06F 7/00

(52) U.S. Cl. 707/10

(57) ABSTRACT

An information deposit and retrieval system based on a resource-property data modeling. An exemplary usage of this system is to describe the properties of documents, pictures, web pages, etc. including their locations in the information deposit and retrieval system. Each document is modeled as a resource. Each resource can be associated with unlimited number of properties. A user can create a resource in the information deposit and retrieval system when he creates a document or comes across a web page by describing the properties of the resource. Later, when the user wants to locate the document, the user issues a query with specifying properties and values to the system. A typical query is to get the “location” property and other property of a resource by giving the values of name, author, and keyword properties. After the matching process, the system returns the matching resources and their location properties.

### CROSS-REFERENCE TO RELATED APPLICATIONS

Reference is made to and priority claimed from U.S. Provisional Application No. 60/240,376, filed Oct. 13, 2000, entitled “Apparatus and Method for Operating an Information Deposit and Retrieval System with Resource Property System,” and is incorporated by reference herein. This application is further related to U.S. application Ser. No. 60/240,375 filed Oct. 13, 2000, entitled “A Method of Translating a Universal Query Language to SQL.”

### FIELD OF THE INVENTION

The present invention relates generally to the storage and retrieval of information from a computer storage system and more particularly to a database system in which data objects are stored according to a property/resource model.

### DESCRIPTION OF THE RELATED ART

Modern storage systems have become very large. The capacity of permanent storage devices, such as magnetic disks, in a personal computer system has reached well over ten gigabytes and hundreds of thousands of files can be stored by such a system. It has become increasingly difficult for a user to find documents, presentations, correspondences, and pictures just on the user's own personal computer. Furthermore, with the popularity of the local area network and the Internet to which the personal computer may be attached, the user may attempt to find a specific document among millions, possibly billions, of documents, web pages and other types of information.

Therefore, there is a need for a search system that makes it easier to locate a file or document without a lot of guesswork and without sorting through a large number of search results.

### BRIEF SUMMARY OF THE INVENTION

One object of the present invention is to provide a method that can easily and accurately locate a file in a storage device by describing the file through one or more properties in the file.

In an exemplary embodiment of the present invention, a method for storing data in a storage device of a resource-property system is disclosed. The data stored conforming to a resource-property model and including the process of creating a new resource for the resource-property system; assigning at least one property to said resource if the resource does not have a property being assigned; adding said resource to the resource-property system; and storing said resource and its property on the storage device.

In another exemplary embodiment or the present invention, a method for retrieving data from a storage device of a resource-property system. The data stored in the storage device conforming to a resource-property model. The method includes specifying at least one property in a query to the resource-property system; querying said resource-property system by searching for matches to said specified property; returning resources that match with said specified property; and obtaining at least one property from the resources returned from the query.

In yet another exemplary embodiment of the present invention, a computer program product embodying a program of instructions executable by a machine to perform method steps for storing data in a storage device of a resource-property system wherein the data stored conforming to a resource-property model. The program of instruction including the processes of creating a new resource for the resource-property system; assigning at least one property to said resource if the resource does not have a property being assigned; adding said resource to the resource-property system; and storing said resource and its property on the storage device.

In still another exemplary embodiment of the present invention, a computer program product embodying a program of instructions executable by a machine to perform method steps for retrieving data from a storage device of a resource-property system wherein the data stored conforming to a resource-property model. The program of instruction including the operations of specifying at least one property in a query to the resource-property system; querying said resource-property system by searching for matches to said specified property; returning resources that match with said specified property; and obtaining at least one property from the resources returned from the query.

In yet another embodiment, a database system for storing data in a storage device of a resource-property system is disclosed. The data stored conforming to a resource-property model. The database system includes means for creating a new resource for the resource-property system; means for assigning at least one property to said resource if the resource does not have a property being assigned; means for adding said resource to the resource-property system; and means for storing said resource and its property on the storage device.

In still another exemplary embodiment, a database system for retrieving data from a storage device of a resource-property system is provided. The data stored in the database system conforms to a resource-property model. The system includes means for specifying at least one property in a query to the resource-property system; means for querying said resource-property system by searching for matches to said specified property; means for returning resources that match with said specified property; and means for obtaining at least one property from the resources returned from the query.

An advantage of the present invention is that it can easily and accurately locate a resource with the precise information, document or file.

### BRIEF DESCRIPTION OF THE DRAWINGS

These and other features, aspects and advantages of the present invention will become better understood with regard to the following description, appended claims, and accompanying drawings where:

FIG. 1 is a block diagram illustrating a computer network interconnecting one or more computer systems, one of which is configured to run the resource/property system of the present invention;

FIG. 2 is a block diagram illustrating a computer network interconnecting one or more computer systems, at least two of which are configured to run the resource/property system of the present invention;

FIG. 3 shows a block diagram of a typical computer system illustrated in FIGS. 1 and 2;

FIG. 4 shows a data structure hierarchy for the data structures of the resource property system;

FIGS. 5A and 5B illustrate pseudo code that describes the data structures of the resource property system;

FIGS. 6A-6E illustrate the elementary functions of the property/resource system of the present invention;

FIG. 7 shows a flow chart illustrating the steps for creating a resource and storing the resource in the storage device of a computer system;

FIG. 8 shows a flow chart illustrating the steps for retrieving a file in the storage system based on its properties;

FIG. 9 shows a flow chart illustrating the steps for updating a file in the storage system;

FIG. 10 shows a flow chart illustrating the steps for removing a file from the storage system; and

FIGS. 11A-11C show a flow charts illustrating the steps for creating a particular resource, adding that resource to the system and for locating the resource within the system.

### DETAILED DESCRIPTION OF THE INVENTION

The present invention provides apparatuses and methods for designing a deposit and retrieval of information system from a computer system or over a computer network based on a resource property system. In the following description, in order to illustrate the present invention, references are made to computer systems and networks. It will be obvious, however, to one of ordinary skill in the art that these systems are provided to illustrate the application of the present invention and are not required to practice the present invention. In other instance, generally understood components of computer systems and networks are not described in detail so as not to unnecessarily obscure or burden the description of the present invention. The embodiments of the present invention described below are provided in software. However, according to the principles of the present invention illustrated below, hardware embodiments of the present invention are also feasible.

Further, the present invention provides a simplified information deposit and retrieval database system based on a new kind of data modeling that offers extreme flexibility in describing information for deposit and retrieval. The primary usage of this system is to describe the properties of documents, pictures, web pages, etc. including their locations in the information deposit and retrieval system. Each document, web pages, pictures, etc. is modeled as a resource. Each resource can be associated with unlimited number of properties. When a user creates a document, or comes across a web page on the Internet, the user can create a resource in the information deposit and retrieval system by describing the properties of the resource, such as name, location, keywords, author, and topic of the resource. Later, when the user wants to locate the document, the user issues a query with specifying properties and values to the system. A typical query is to get the “location” property and other property of a resource by giving the values of name, author, and keyword properties. The more properties and values that are given, the more accurate the search results are. After the matching process, the system returns the matching resources and their location properties.

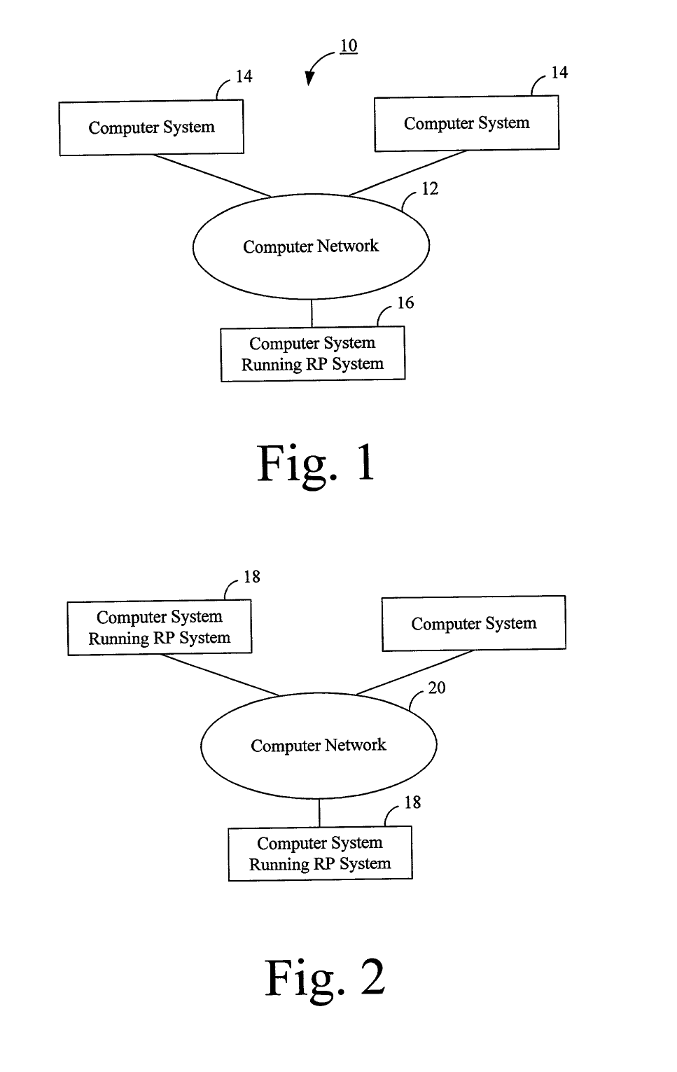

FIG. 1 is a block diagram illustrating a computer network system lo interconnecting one or more computer systems, one of which is configured to run the resource/property system of the present invention. A computer network 12 interconnects a plurality of computer systems 14, 16, one of which, i.e., the computer system 16, runs the resource/property (RP) system. The resource property residing in the computer system 16 can be accessed via the computer system 16 by other computer systems 14 or via the computer network 12. Alternatively as shown in FIG. 2, at least two computer systems 18, interconnected by a computer network 20, are configured to run the resource/property system of the present invention.

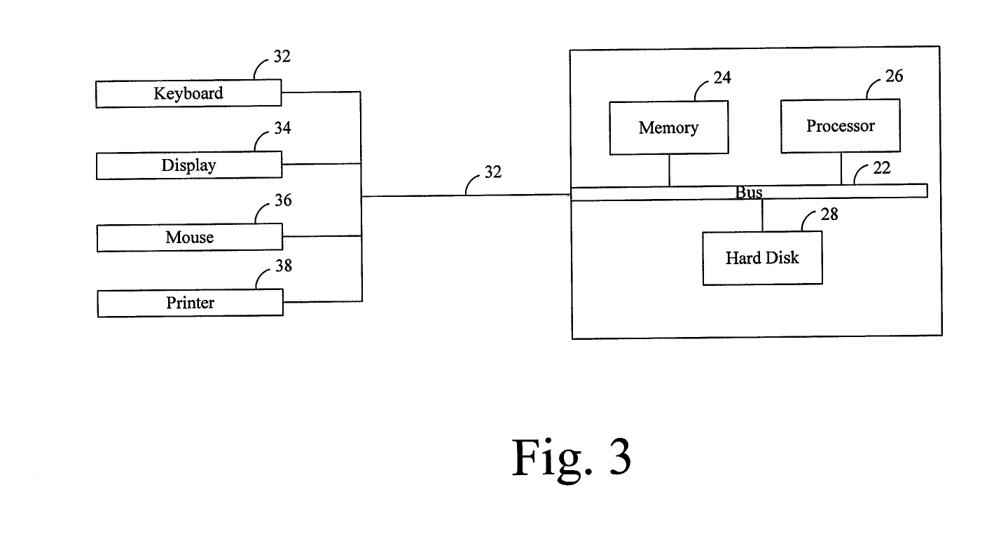

FIG. 3 shows a representative computer systems shown in FIGS. 1 and 2, in which a central bus 22 interconnects a memory subsystem 24, a processor 26 and a hard disk storage device 28 and there is an interface between an I/O bus 30 to the central bus 22. The I/O bus 30 hosts a standard set of peripheral devices such as a keyboard 32, display 34, mouse 36 and printer device 38.

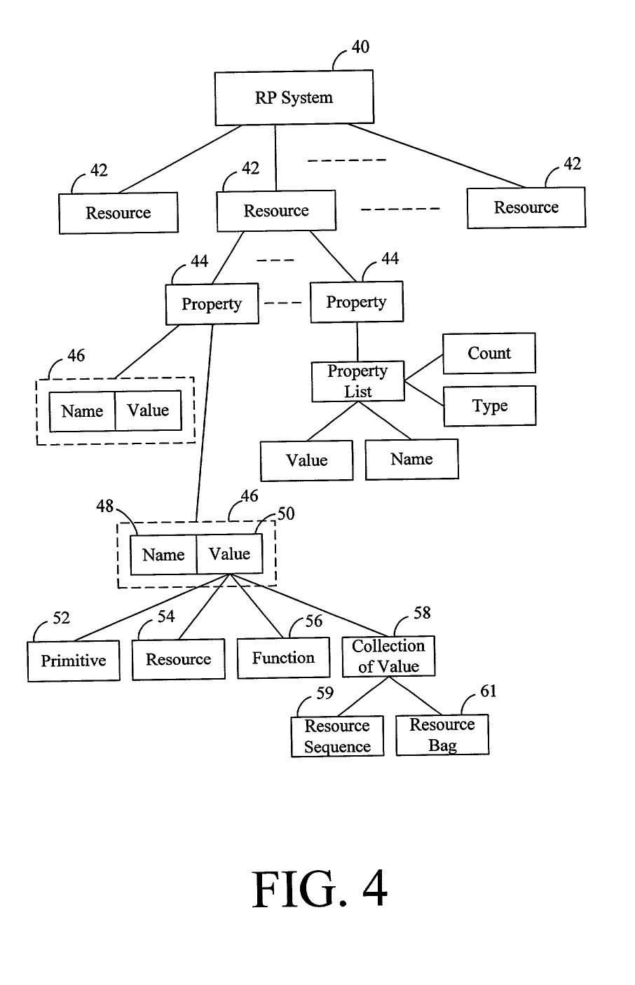

FIG. 4 shows a data structure hierarchy for the data structures of the resource property system. A resource property system 40 includes a plurality of resources 42 and each resource has one or more properties 44. A property comprises a name/value pair 46, where the name 48 is a string of characters and different properties of the same resource must have different names. The value 50 in the name/value pair 46 is either a primitive value 52, a resource 54, a function 56, or a collection of values 58.

A primitive value 52 is one that is not a resource, a function or a collection. Examples of primitive values are integers, numbers, binary values, and pictures.

A function 56 is something that can accept arguments and return results through invocation.

A collection is either a sequence 59 or a bag 61, wherein a sequence 59 is an ordered collection of values and a bag 61 is a collection of values that are not presented or arranged in order, or a collection of values presented in random order.

The name 48 provides an identity to the property and can be generally referred to as an “ID” to the property. Although not essential, a reserved property name is an “ID”, which is used to quickly identify a resource. The content of an “ID” is preferably unique within a single Resource Property system. If a system that ensures unique values of all “ID's” of its resources, it is a unique ID system. A unique ID system does not guarantee that all resources have an “ID”, just that if resources have ID's, the ID's are unique.

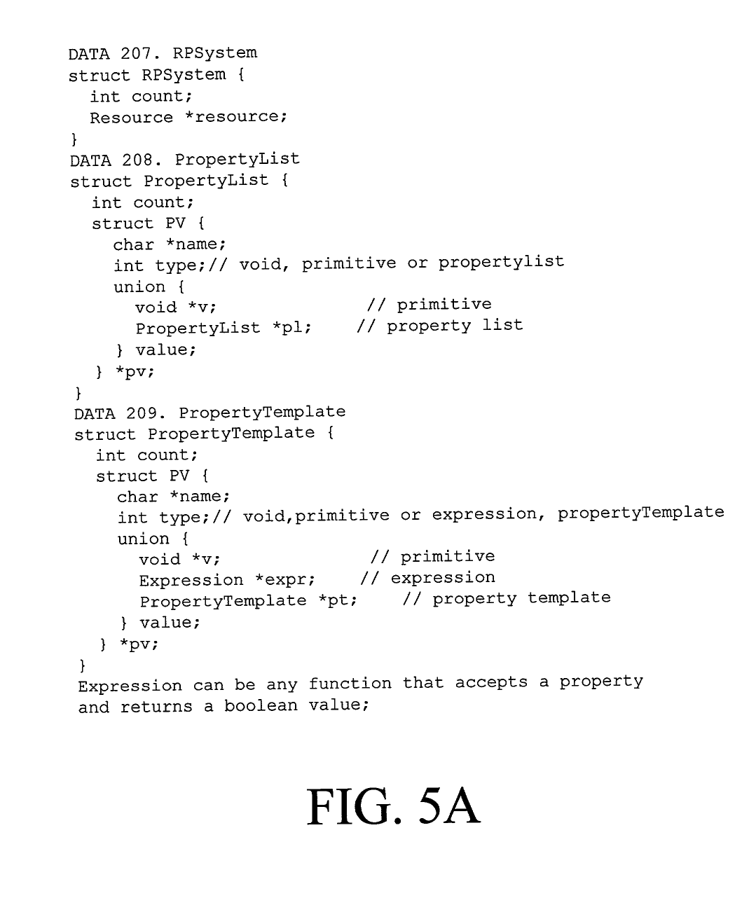

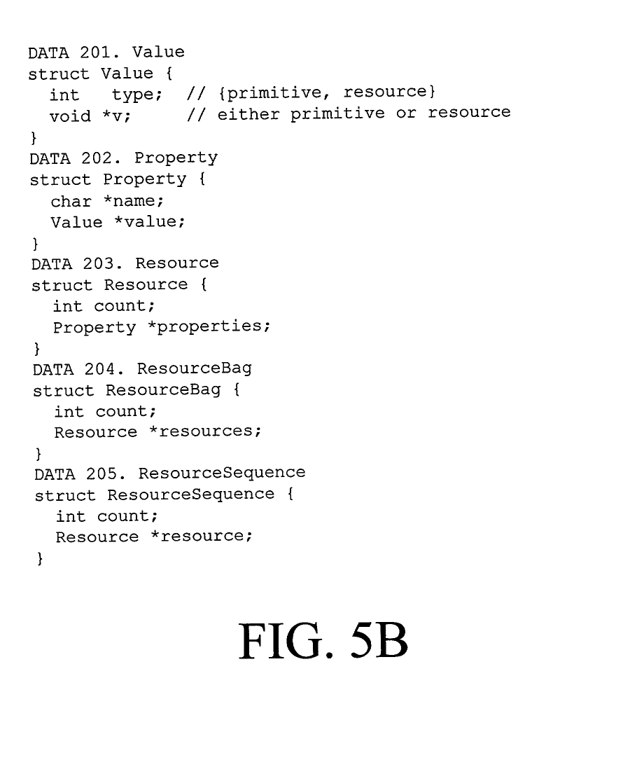

FIGS. 5A and 5B illustrate pseudo C code similar to C programming language, that describes the data structures of the resource property system 30 of the present invention. In FIG. 5A, data structure 207 defines the RP System 40 (FIG. 4) structure which includes a count and a pointer to one or more resources 42. In FIG. 5B, data structure 203 defines a Resource 42 as including a count and a number of properties 44 and data structure 202 declares that a property is a name 48, value 50 (pointer) pair 46.

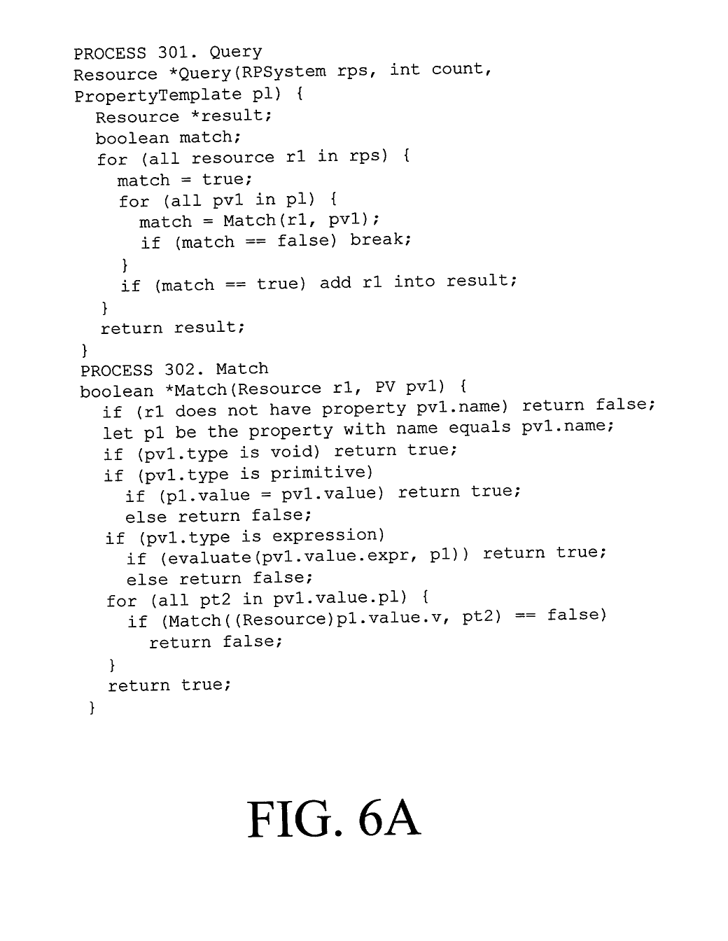

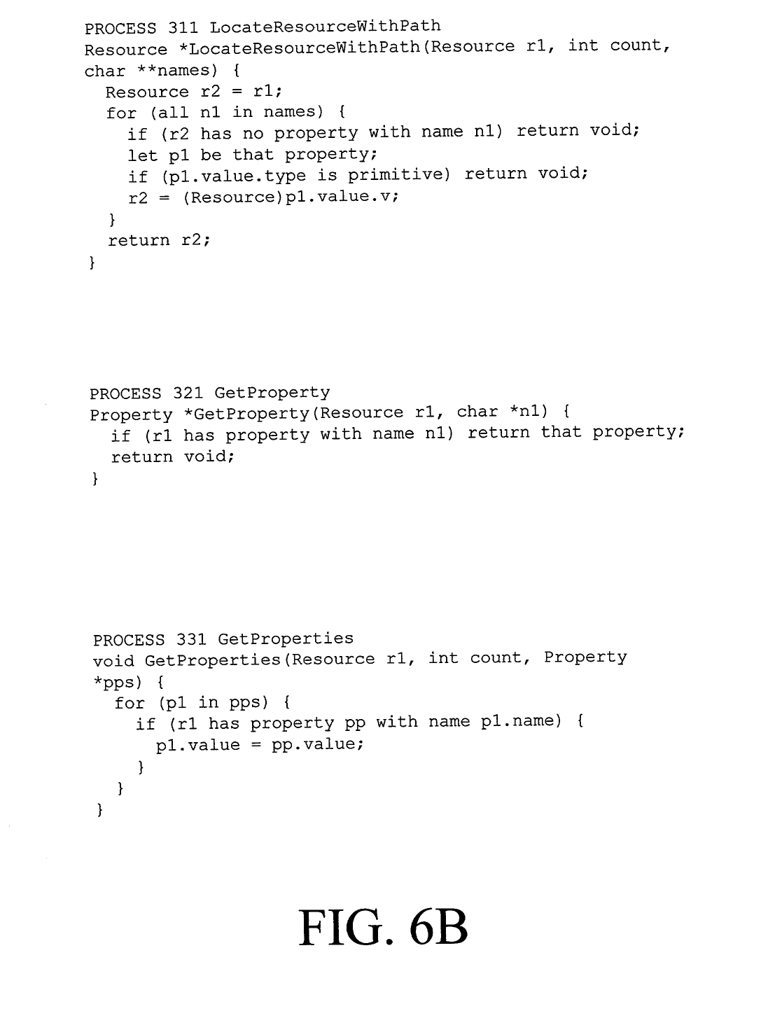

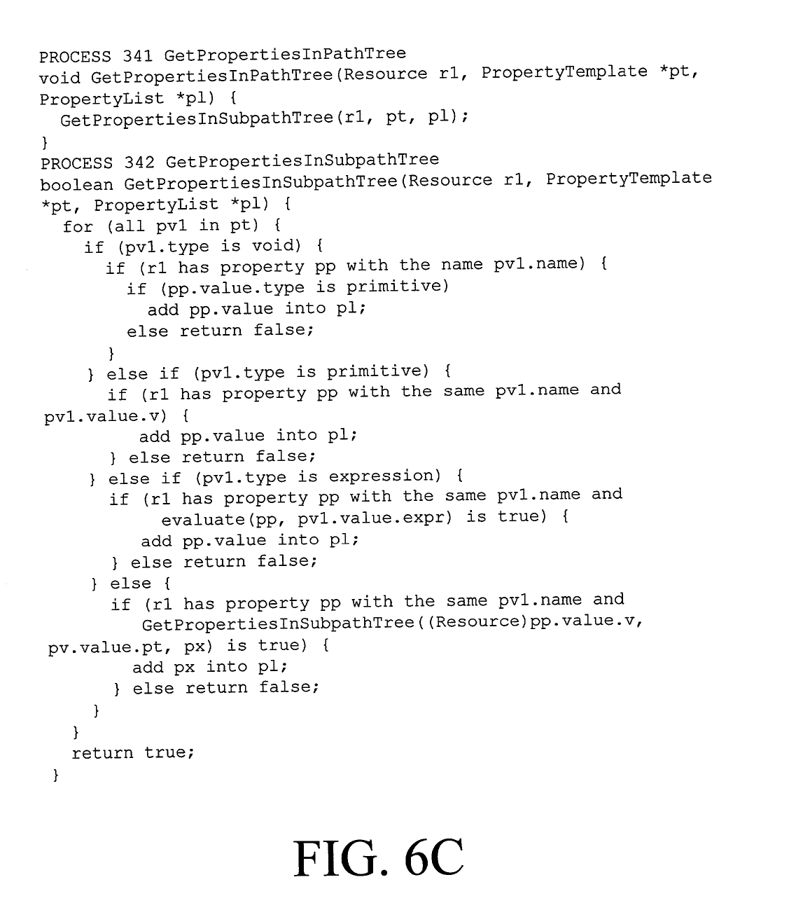

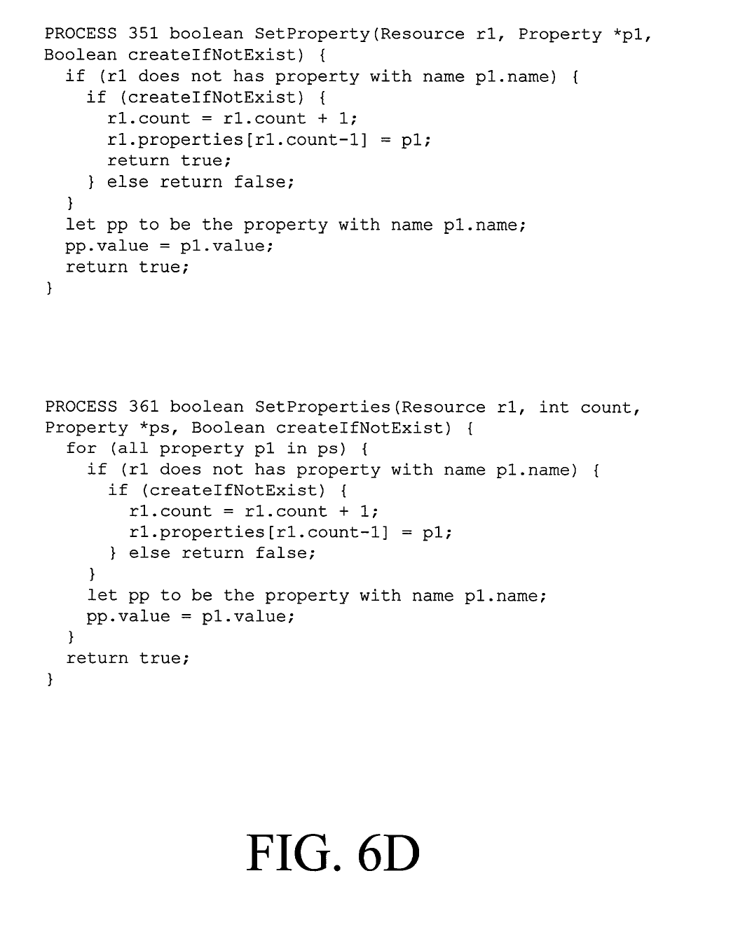

FIGS. 6A-6E illustrate the elementary functions of the resource/property system 40 (FIG. 4) of the present invention. In processes 301 and 302 (FIG. 6A), the query operation, the caller fills the PropertyTemplate data structure, with name and value, expression and its child properties. It is not necessarily to fill all the values. The resource property system examines the properties in the template and compares them with the stored resources. A resource satisfies a property if it has a property with the same name and (1) if the value of the property is void; or (2) if the value of the property is the same as the resource's property value or satisfies the expression; or (3) if the value of the resource's property is a resource, it satisfies the child properties of the property template. When a resource satisfies all properties in the PropertyTemplate, it is placed in the result and returned to the caller.

In process 311 (FIG. 6B), a resource is located via a property path. Since the value of a property of a resource can be another resource, the former can be said to have a property link to the latter. The latter resource can have property links to other resources. If one resource is reachable by another resource through such connected property links, the latter has a property path to the former. Since one resource may have multiple links to other resources and it is possible to have a path pointing back to its original resource, the whole property link system may form a property web, connecting resources together. A resource property system may have many disjointed property webs. A resource can be located uniquely through another resource if a property path from the latter to the former exists. In the locating process of process 311, the system takes the starting resource and an array of property names. It checks whether the starting resource has a property name that is the same as the first property name in the array. If it does not, the process returns void. If it does and the value is a resource, it repeats the process until the last name in the array is matched. The final resource is returned.

Process 321 illustrates an exemplary code for getting a single property from a resource. The input data are the resource and the name of the property. The properties of the resource are examined and the property of the same name is returned.

Process 331 illustrates the code for getting multiple properties of a resource in one operation. The input data r1 are the resource, a count, which is the number of properties in pps, and a property pointer, pps, which points to the properties to be obtained. Only the name field in the pps is supplied. After the operation, the value of the properties in pps are filled or left void if no such property exists.

Processes 341 and 342 (FIG. 6C) illustrate the code for getting properties by means of a property path tree. From a single resource, it is possible to travel the property path tree to obtain multiple properties. The process is as follows. The system first obtains the resource's properties whose name is specified in the first level of the property list. For any value that is a resource, it transverses to the next level. If any of the next level's property has both name and value specified, it acts as a filter. If the resource's property of the same name has a different value, that resource is ignored. Otherwise the value of the next level is filled. The process goes down to the next level again, as shown in the code.

Process 351 (FIG. 6D) illustrates the code for setting a single property of a resource. The input data are the resource, the property and a Boolean to indicate whether to create the property if it does not exit. The value of the property of the resource is set to the new value. If the property does not exit and the createIfNotExist is true, the property is created.

Process 361 illustrates the code for setting multiple properties for a resource. The input data are the resource, the properties and a Boolean to indicate whether to create a property if it does not exit. The value of each property in the properties of the resource is set to the new value. If a property does not exit and the createIfNotExist is true, it is created.

Process 371 (FIG. 6E) illustrates the code for creating a new resource. The input data are the count of elements in the properties and the properties.

Process 381 illustrates the code for adding a resource. The input data are the RPSystem and the resource.

Process 391 illustrates the code for removing a resource. The input data are the RPSystem and the resource.

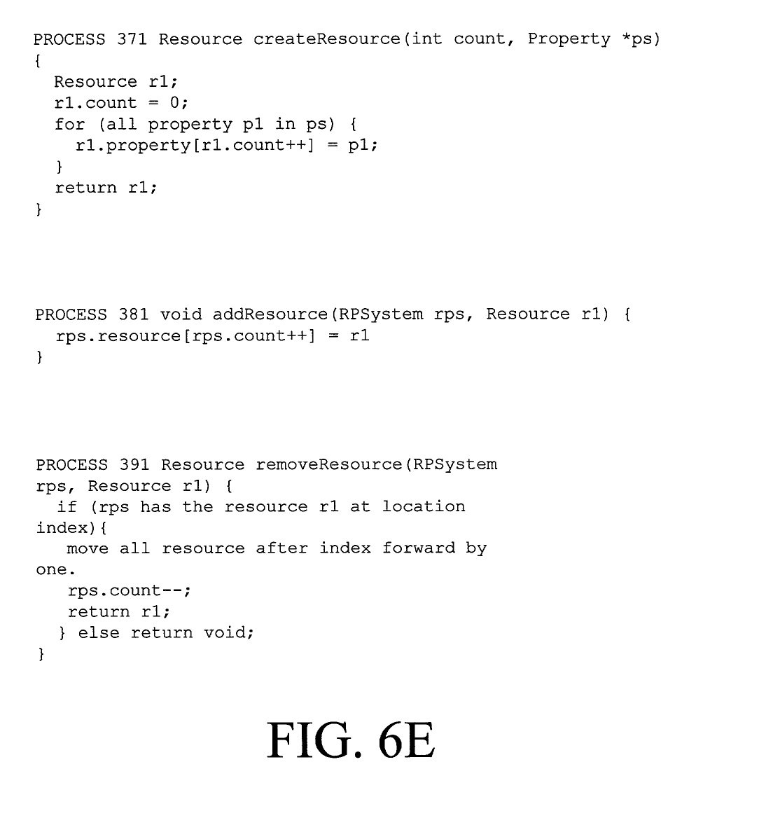

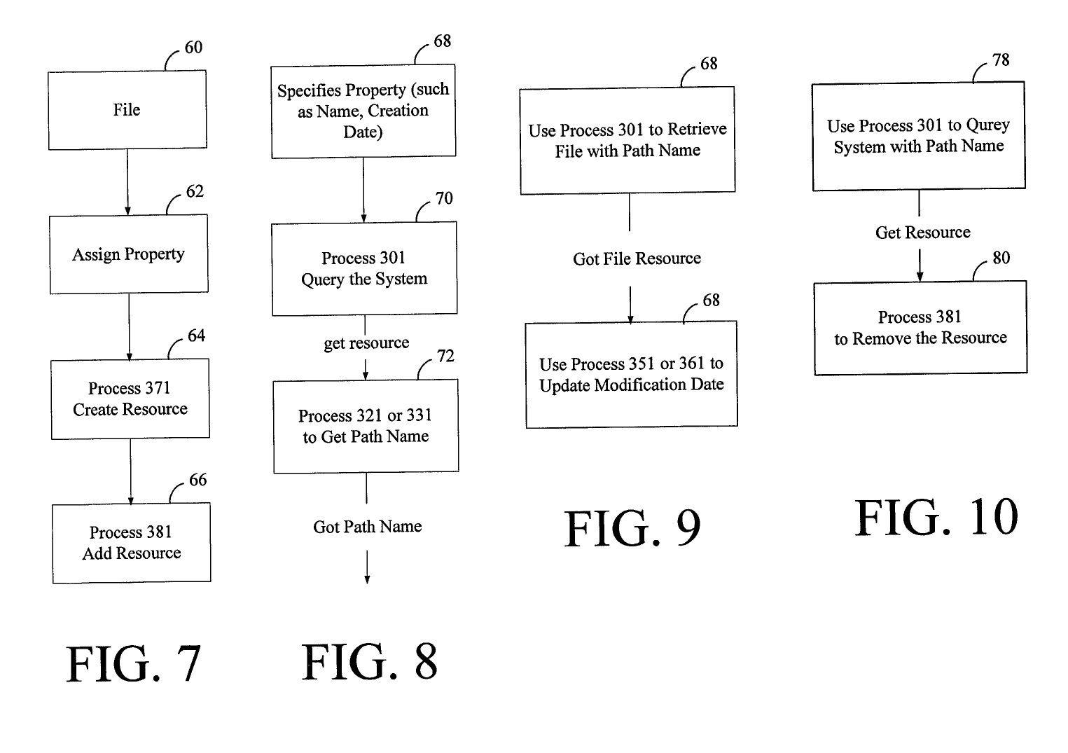

FIG. 7 shows a flow chart illustrating the steps for creating a resource and storing the resource in the storage device of a computer system. In this example, a person has a large file system 60 and desires to use the Resource Property System to manage the files contained therein.

Step 1 (62). Each file in the file system is modeled as a resource with properties, file name, path name, date of creation, date of last modification, signature, topic and keywords.

Step 2 (64). Through calling process 371 described above and illustrated in FIG. 6E, a new resource with the file's properties is created. It is not necessary to set all the properties of a file before it can be used. An application program can be built to automate this process as an alternative.

Step 3 (66). Through calling process 381 as described above in conjunction with FIG. 6E, files are added into the Resource Property System.

FIG. 8 shows a flow chart illustrating the steps for retrieving a file in the storage system based on its properties.

Step 1 (68). The user can retrieve the file by specifying the property through its name, creation date, etc.

Step 2 (70). If the user does not remember where a file is stored, the user can invoke an inquiry by providing information about the topic, and a list of keywords related to the file and call process 301 to retrieve the resource.

Step 3 (72). Through calling process 321 or process 331, a user can obtain the path name from the retrieved resource of the file. When calling Process 321, the user may specify the resource and the name of the property. The properties of the resource are examined and the property of the name is returned. As described above, by calling Process 331, a plurality of properties of a resource may be obtained at the same time.

FIG. 9 shows a flow chart illustrating the steps for updating a file in the storage system.

Step 1 (74). As described above in connection with FIG. 6A, a user may call Process 301 with path name, value, expression, or its child properties to retrieve the resource of the file to modify such file. However, the user does not have to provide all the above information to retrieve the resource of the file to modify such file.

Step 2 (76). As described above and illustrated in FIG. 6D, a user may call Process 351 or Process 361 to update the modification date of a file. When calling Process 351, the user provides the resource, the property and a Boolean to indicate whether or not to create the property if it does not exist. When calling Process 361, the user provides the resource, the properties, and a Boolean to indicate whether or not to create a property if it does not exist.

FIG. 10 shows a flow chart illustrating the steps for removing a file from the storage system.

Step 1 (78). As described above, a user may call Process 301 to retrieve the resource of the file.

Step 2 (80). Once the file is retrieved, the user proceeds by calling Process 381 to remove the resource.

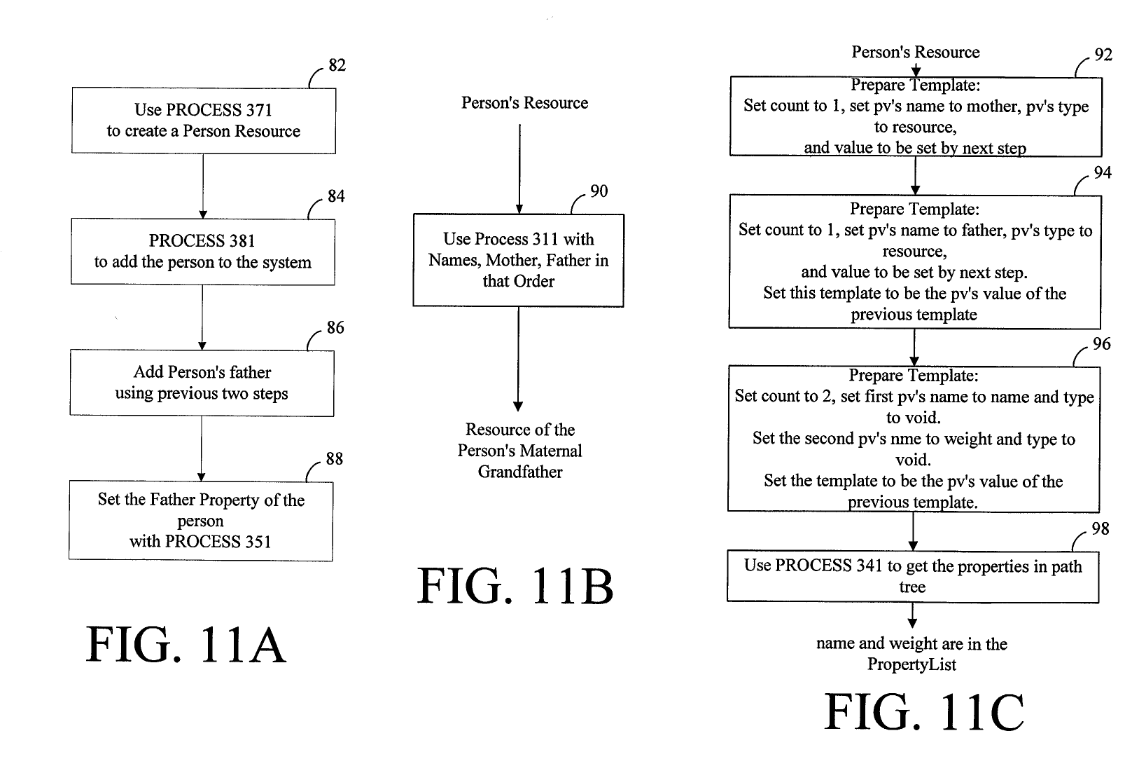

FIGS. 11A-11C show flow charts illustrating the steps for creating a particular resource, adding that resource to the system, and for locating the resource within the system. Semi-structured data are data that are not uniform structured. For example, a person's family information is semi-structured. Resource Property System might be used to manage semi-structure data.

FIG. 11A illustrates the steps of adding a person to the RP system.

Step 1 (82). Creating a resource for a person by calling Process 371 by providing the RP system and the resource. The properties are name, age, weight, and height.

Step 2 (84). Adding the resource into the system through calling Process 381 by providing the RP system and the resource.

Steps 3 (86) and 4 (88). If the person's father is also a resource, set the father's resource to be the value of the new property “father” through process 351. By repeating the same process, more members of the family, such as mother, spouse and children if any, can also be added to the RP system.

FIG. 11B illustrates the steps of finding a related person in the system.

Step 1 (90). Through Process 311, a resource can be located uniquely through another resource if a property path from the latter to the former exists. Therefore, through calling Process 311 with the first element of names to be the “mother” and the second element of names to be the “father”. The result is the resource of the person's maternal grandfather.

FIG. 11C illustrates the steps of finding information about the related person.

Step 1 (92). This step prepares the template by setting the first level template's count to 1, pv's name to “mother”, type to “resource”, and value to be set by the next step.

Step 2 (94). Set the second level template's count to 1, pv's name to “father”, type to “resource” and set the pv's value of the first level template to be the second level template.

Step 3 (96). Set the third level template's count to 2, the first pv's name to “name” and type to “void” and the second pv's name to “weight” and type to “void”. Set the second level template's pv's value to be the third level template.

Step 4 (98). Use PROCESS 341 with template to be “Mother, Father {name, weight}”. The result is the name and the weight.

Although the present invention has been described in considerable detail with reference to certain preferred versions thereof, other versions are possible. Therefore, the spirit and scope of the appended claims should not be limited to the description of the preferred versions contained herein.

What is claimed is:

1. A method for storing data in a storage device of a resource-property system, the data stored conforming to a resource-property model, comprising:
creating a new resource for the resource-property system;
assigning at least one property to said resource if the resource does not have a property being assigned;
adding said resource to the resource-property system; and
storing said resource and its property on the storage device.

2. A method for storing data in a storage device of a resource-property system as recited in claim 1, wherein said property being assigned to the resource is a name/value pair;

3. A method for storing data in a storage device of a resource-property system as recited in claim 2, wherein the value portion of the name/value pair being selectable from a group consisting of a primitive value, a resource name, a function, and a collection of value.

4. A method for storing data in a storage device of a resource-property system as recited in claim 3, wherein said collection of value including a resource sequence which is an ordered collection of values.

5. A method for storing data in a storage device of a resource-property system as recited in claim 3, wherein said collection of value including a resource bag which is a collection of value that are not presented in order.

6. A method for storing data in a storage device of a resource-property system as recited in claim 3, wherein said collection of value including a source bag which is a collection of value presented in random order.

7. A method for retrieving data from a storage device of a resource-property system, the data stored conforming to a resource-property model, comprising: specifying at least one property in a query to the resource-property system;
querying said resource-property system by searching for matches to said specified property;
returning resources that match with said specified property; and
obtaining at least one property from the resources returned from the query.

8. A method for retrieving data from a storage device of a resource-property system as recited in claim 7, wherein said returned resource match with said specified property having a value that is the same as the resource's property value.

9. A method for retrieving data from a storage device of a resource-property system as recited in claim 7, wherein said property is being specified in an expression.

10. A method for retrieving data from a storage device of a resource-property system as recited in claim 9, wherein said returned resource match with said specified property having a value that satisfies the expression.

11. A method for retrieving data from a storage device of a resource-property system as recited in claim 7, wherein said returned resource having another resource as its property.

12. A computer program product embodying a program of instructions executable by a machine to perform method steps for storing data in a storage device of a resource-property system wherein the data stored conforming to a resource-property model, comprising:
creating a new resource for the resource-property system;
assigning at least one property to said resource if the resource does not have a property being assigned;
adding said resource to the resource-property system; and
storing said resource and its property on the storage device.

13. A computer program product embodying a program of instructions executable by a machine to perform method steps for storing data in a storage device of a resource-property system as recited in claim 12, wherein said property being assigned to the resource is a name/value pair;

14. A computer program product embodying a program of instructions executable by a machine to perform method steps for storing data in a storage device of a resource-property system as recited in claim 13, wherein the value portion of the name/value pair being selectable from a group consisting of: a primitive value, a resource name, a function, and a collection of value.

15. A computer program product embodying a program of instructions executable by a machine to perform method steps for storing data in a storage device of a resource-property system as recited in claim 14, wherein said collection of value including a resource sequence which is an ordered collection of values.

16. A computer program product embodying a program of instructions executable by a machine to perform method steps for storing data in a storage device of a resource-property system as recited in claim 14, wherein said collection of value including a resource bag which is a collection of value that are not presented in order.

17. A computer program product embodying a program of instructions executable by a machine to perform method steps for storing data in a storage device of a resource-property system as recited in claim 14, wherein said collection of value including a source bag which is a collection of value presented in random order.

18. A computer program product embodying a program of instructions executable by a machine to perform method steps for retrieving data from a storage device of a resource-property system, the data stored conforming to a resource-property model, comprising:
specifying at least one property in a query to the resource-property system;
querying said resource-property system by searching for matches to said specified property;
returning resources that match with said specified property; and
obtaining at least one property from the resources returned from the query.

19. A computer program product embodying a program of instructions executable by a machine to perform method steps for retrieving data from a storage device of a resource-property system as recited in claim 18, wherein said returned resource match with said specified property having a value that is the same as the resource's property value.

20. A computer program product embodying a program of instructions executable by a machine to perform method steps for retrieving data from a storage device of a resource-property system as recited in claim 18, wherein said property is being specified in an expression.

21. A computer program product embodying a program of instructions executable by a machine to perform method steps for retrieving data from a storage device of a resource-property system as recited in claim 20, wherein said returned resource match with said specified property having a value that satisfies the expression.

22. A computer program product embodying a program of instructions executable by a machine to perform method steps for retrieving data from a storage device of a resource-property system as recited in claim 18, wherein said returned resource having another resource as its property.

23. A database system for storing data in a storage device of a resource-property system, the data stored conforming to a resource-property model, comprising:
means for creating a new resource for the resource-property system;
means for assigning at least one property to said resource if the resource does not have a property being assigned;
means for adding said resource to the resource-property system; and
means for storing said resource and its property on the storage device.

24. A database system for storing data in a storage device of a resource-property system as recited in claim 23, wherein said property being assigned to the resource is a name/value pair;

25. A database system for storing data in a storage device of a resource-property system as recited in claim 24, wherein the value portion of the name/value pair being selectable from a group consisting of: a primitive value, a resource name, a function, and a collection of value.

26. A database system for storing data in a storage device of a resource-property system as recited in claim 25, wherein said collection of value including a resource sequence which is an ordered collection of values.

27. A database system for storing data in a storage device of a resource-property system as recited in claim 25, wherein said collection of value including a resource bag which is a collection of value that are not presented in order.

28. A database system for storing data in a storage device of a resource-property system as recited in claim 25, wherein said collection of value including a source bag which is a collection of value presented in random order.

29. A database system for retrieving data from a storage device of a resource-property system, the data stored conforming to a resource-property model, comprising:
means for specifying at least one property in a query to the resource-property system;
means for querying said resource-property system by searching for matches to said specified property;
means for returning resources that match with said specified property; and
means for obtaining at least one property from the resources returned from the query.

30. A method for retrieving data from a storage device of a resource-property system as recited in claim 29, wherein said returned resource match with said specified property having a value that is the same as the resource's property value.

31. A method for retrieving data from a storage device of a resource-property system as recited in claim 29, wherein said property is being specified in an expression.

32. A method for retrieving data from a storage device of a resource-property system as recited in claim 29, wherein said returned resource match with said specified property having a value that satisfies the expression.

33. A method for retrieving data from a storage device of a resource-property system as recited in claim 29, wherein said returned resource having another resource as its property.
